(19) United States
(12) Patent Application Publication
(10) Pub. No.: US 2023/0376733 A1
(43) Pub. Date: Nov. 23, 2023

(54) CONVOLUTIONAL NEURAL NETWORK ACCELERATOR HARDWARE

(71) Applicant: RUTGERS, THE STATE UNIVERSITY OF NEW JERSEY, New Brunswick, NJ (US)

(72) Inventors: Santosh Nagarakatte, Piscataway, NJ (US); Richard P. Martin, Piscataway, NJ (US); Mohammadreza Soltaniyeh, Piscataway, NJ (US)

(21) Appl. No.: 18/198,579

(22) Filed: May 17, 2023

Related U.S. Application Data
(60) Provisional application No. 63/342,917, filed on May 17, 2022.

(51) Int. Cl. G06N 3/0464; G06F 17/16

(52) U.S. Cl. CPC G06N 3/0464; G06F 17/16

(57) ABSTRACT

A hardware accelerator for neural network applications can include an image-to-column block and a general matrix-matrix multiplication (GEMM) block. The image-to-column block includes an input controller coupled to receive an input feature map from a memory block; a series of patch units configured in a ring network and coupled to the input controller to receive new elements of the input feature map; and an output controller coupled to receive each output patch from the series of patch units. The GEMM block can be a dynamically reconfigurable unit that can be configured as a tall array or individual square arrays. The described hardware accelerator can handle sparsity in both the feature map inputs (output from the image-to-column block) and the filter/weight inputs to the GEMM block.

### CROSS-REFERENCE TO RELATED APPLICATION

This application claims the benefit of U.S. Provisional Application Ser. No. 63/342,917, filed May 17, 2022.

### GOVERNMENT SUPPORT

This invention was made with government support under Grant No. 1908798 awarded by the National Science Foundation (NSF). The Government has certain rights in the invention.

### BACKGROUND

Neural networks are widely used in numerous domains such as video processing, speech recognition, and natural language processing. While training of such neural networks typically is performed in the cloud or on a large cluster of machines to obtain high accuracy, it is often desirable to compute the inference tasks on the edge devices. Computing at the edge devices (e.g., mobile devices or in the context of Internet of Things (IoT)) is beneficial when network connectivity is either unavailable or is limited. Edge devices tend to have limited memory and compute resources with strict requirements on energy usage. Therefore, it can be difficult to perform complex computations on edge devices.

Hardware acceleration is an area of interest to enable neural network operations at edge devices. Hardware acceleration refers to the design of computer hardware to perform specific functions instead of using software running on a general-purpose computer processor.

Among various neural networks, convolutional neural networks (CNNs) are widely used in many applications, such as image processing. CNNs can have multiple types of layers, including convolution layers, fully connected layers, and pooling layers, with the majority of the computation belonging to the convolution layers. Each CNN layer has multiple features such as the number of filters, kernel size, stride size, and channel size. This creates a diverse set of layers with unique features, which makes designing a hardware accelerator that can perform adequately for all types of CNNs layers challenging. Further, supporting sparse inputs introduces additional complexity to the design.

Thus, there is a need for improved accelerator hardware.

### BRIEF SUMMARY

A hardware accelerator for neural network applications is provided. The described hardware accelerator is suitable for implementing convolutional neural networks.

A hardware accelerator for neural network applications can include an image-to-column block and a general matrix-matrix multiplication (GEMM) block.

An image-to-column block is provided that includes an input controller coupled to receive an input feature map from a memory block; a series of patch units forming a ring network and coupled to the input controller to receive new elements of the input feature map, wherein each patch unit in the series of patch units is used for generating one output patch; and an output controller coupled to receive each output patch from the series of patch units, wherein the output controller organizes each output patch for output to a GEMM block.

Each patch unit in the series of patch units of the image-to-column block can include a series of local buffers. As elements of the input feature map are streamed in to the series of patch units, each patch unit forwards overlapping elements to a neighboring patch unit in the series of patch units, where the overlapping elements are elements of the input feature map that are shared between two rounds of sliding a filter as the filter slides over the input feature map horizontally and vertically. This exploitation of localities resulting from the overlap as the filter slides over the input feature map horizontally and vertically results in reading the input feature map from the memory block one time.

The GEMM block can include a systolic array of processing elements.

In some cases, the hardware accelerator can further include a second image-to-column block, a second GEMM block, and a mode selector. The mode selector is used to configure the hardware accelerator for a tall mode where the GEMM block and the second GEMM block are combined to form a tall systolic array with one image-to-column block in use and a square mode where each GEMM block with corresponding image-to-column block is separately operated.

The described hardware accelerator can handle sparsity in both the feature map inputs (output from the image-to-column block) and the filter/weight inputs to the GEMM block. For example, sparsity in weights and in the results of the image-to-column block can be handled by the hardware accelerator through use of metadata and selective application of the weights and the results of the image-to-column block to the GEMM.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment of a hardware accelerator for neural network applications in accordance with embodiments described herein.

FIG. 2 shows a representational diagram of a hardware accelerator for neural network applications in accordance with embodiments described herein.

FIG. 3 illustrates matrix-matrix multiplication for performing a convolution operation.

FIG. 4 shows an example implementation of the hardware accelerator of FIG. 2.

FIGS. 5A and 5B demonstrate a dynamic reconfigurable GEMM block.

FIGS. 6A and 6B illustrate an image-to-column unit.

FIGS. 7A-7C illustrate example operations of an image-to-column unit in accordance with embodiments described herein.

FIGS. 8A-8C illustrate example operations of a GEMM block in accordance with embodiments described herein.

FIGS. 9A-9F illustrate techniques for handling sparsity in inputs to the GEMM block in accordance with embodiments described herein.

FIG. 10 illustrates a pruning operation.

### DETAILED DESCRIPTION

A hardware accelerator for neural network applications is provided. The described hardware accelerator is suitable for implementing convolutional neural networks.

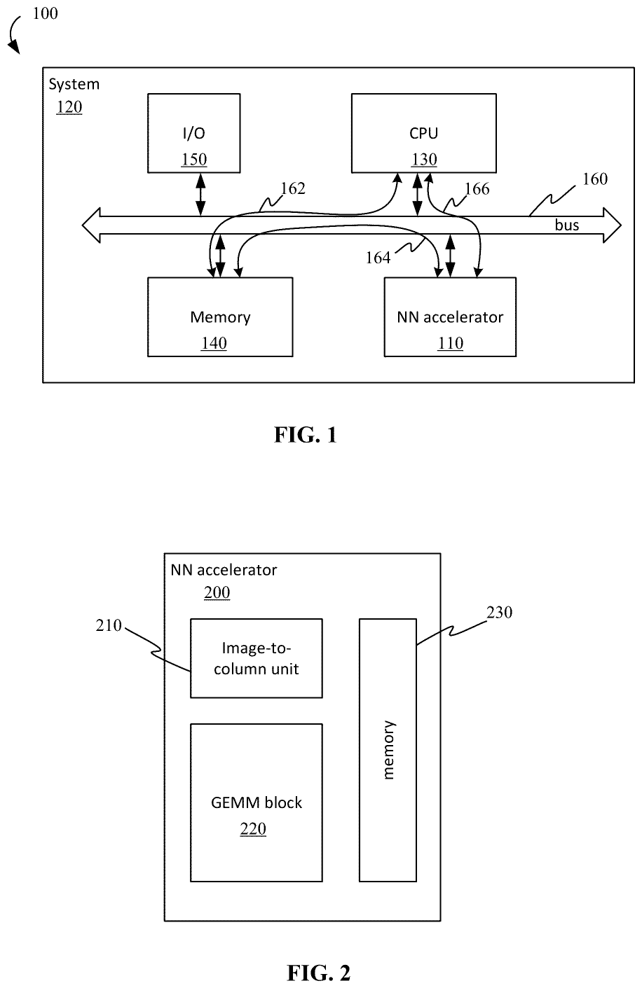

FIG. 1 illustrates an operating environment of a hardware accelerator for neural network applications in accordance with embodiments described herein. Referring to FIG. 1, in an example operating environment 100, a hardware accelerator for neural network applications (“NN accelerator”) 110 can be implemented as part of a computing system 120 to support the offloading of certain operations, as described herein, from a processor 130. For example, the NN accelerator 110 can implement convolutional layers for a convolutional neural network (CNN).

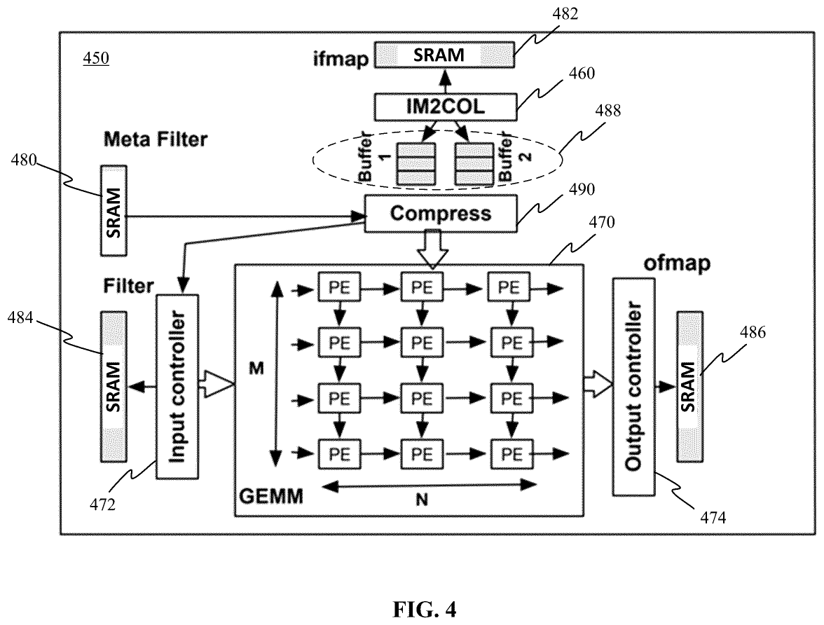

One approach to implement CNNs is to realize a convolutional layer in software as a large, single General Matrix-Matrix Multiplication (GEMM) using a data reorganization transformation called Image-to-Column (IM2CoL). While some acceleration to the convolution computation is possible by offloading the GEMM to hardware, by further including the IM2COL in hardware at the NN accelerator 110, significant acceleration can be achieved including avoiding the significant data transfer between the processor 130 and the hardware accelerator (NN accelerator 110). NN accelerator 110 may be implemented such as described with respect to FIGS. 2 and 4.

Computing system 120 is, for example, an edge device (e.g., a mobile device or an IoT device). Alternatively, computing system 120 can be a rack mount device, server, or other computing device such as used as part of an on-premise data center or cloud data center.

Computing system 120 can include the NN accelerator 110, the processor 130, memory 140, and input/output (I/O) interface 150, which are connected via bus 160. The processor 130 can include, for example, a general-purpose central processing unit (CPU), graphics processing unit (GPU), or other hardware processing units. Memory 140 stores data and programs, including software for a variety of inferencing-related applications. The memory 140 can include, for example, volatile memory (e.g., random-access memories such as SRAM and DRAM) and nonvolatile memory (e.g., flash, ROM, EPROM, and ferroelectric and other magnetic-based memories). The I/O interface 150 enables communication between a user and/or other devices and the system 120 and may include user interface components and/or communications (e.g., network interface) components. System 120 can use I/O interface 150 to communicate with remote devices (e.g., cloud-based or on-premise) for performing training processes for the neural network implemented at system 120. The bus 160 transfers data between components in system 120. Although a single bus is shown, bus 160 may be formed of various buses and may be implemented in any suitable configuration.

Instructions of the software for an inferencing-related application stored on memory 140 can be read from memory 140 over the bus 160 (e.g., via communication path 162) and executed by the processor 130. Data stored on memory 140 can be read from and written to memory 140 by the processor 130 over the bus 160 (e.g., via the communication path 162). The NN accelerator 110 can receive data stored in memory 140 and output data to memory over bus via communication path 164. The NN accelerator 110 and the processor 130 can communicate over the bus 160 as shown by communication path 166.

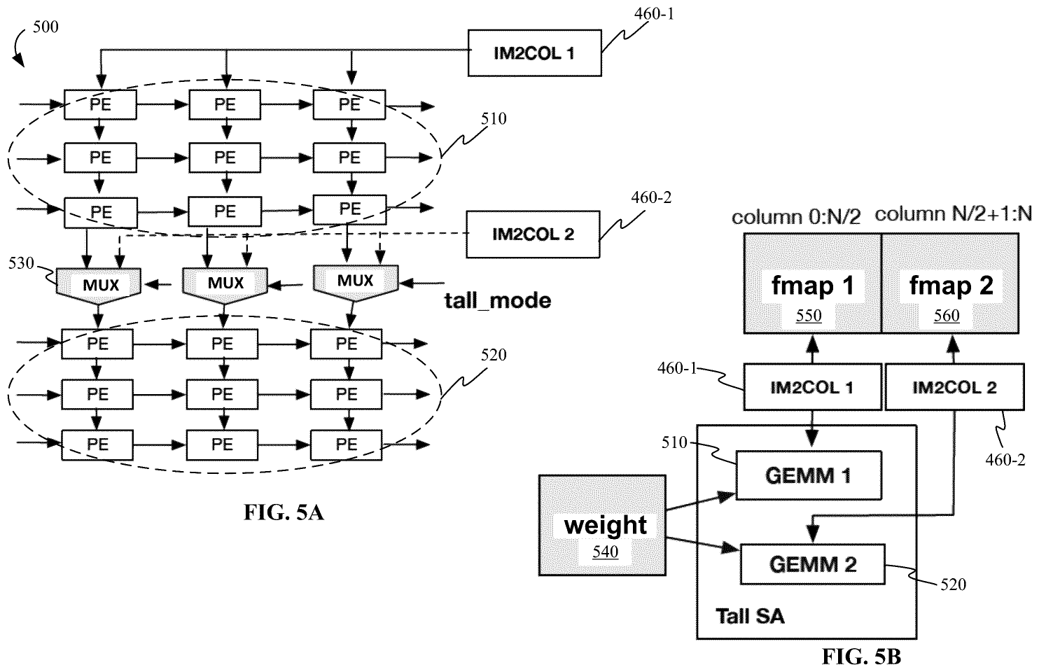

FIG. 2 shows a representational diagram of a hardware accelerator for neural network applications in accordance with embodiments described herein. Referring to FIG. 2, a hardware accelerator 200 includes an image-to-column unit 210, GEMM block 220, and memory 230. These components may be provided in plurality (see e.g., FIG. 5A, which shows multiple image-to-column units and GEMM blocks). The memory 230 of the hardware accelerator 200 includes multiple memory regions and can be implemented using static random access memory (SRAM). The memory 230 can be implemented as multiple small SRAM blocks (e.g., separately storing filters, metadata, and feature maps such as shown in FIG. 4; and/or storing associated feature maps such as fmap 1 550 and fmap 2 560 shown in FIG. 5B). The hardware accelerator 200 is suitable for accelerating convolution computations for a CNN.

A CNN consists of a series of layers. Each layer in a CNN extracts a high-level feature of the input data called a feature map (fmap). CNNs often have different layers, including convolution, activation (e.g., non-linear operator), pooling, and fully connected layers. The convolutional layers are the main layers in a CNN. They perform the bulk of the computation. Each convolution layer has several filters. The values of these filters (i.e., weights) are learned during the training phase. In the inference phase, the network classifies new inputs presented to the network. Typically, a collection of N input feature maps are convolved with K filters (i.e., a batch size of N). For inference tasks, it is common to use a batch size of 1. The convolution operation can be transformed into general matrix-matrix multiplication using the IM2COL transformation. As can be seen in FIG. 2, both the GEMM operation and the IM2COL operation for the CNN are implemented on the hardware accelerator via the image-to-column unit 210 and GEMM block 220. The remaining operations can be performed in software on the main processor (e.g., processor 130 of FIG. 1).

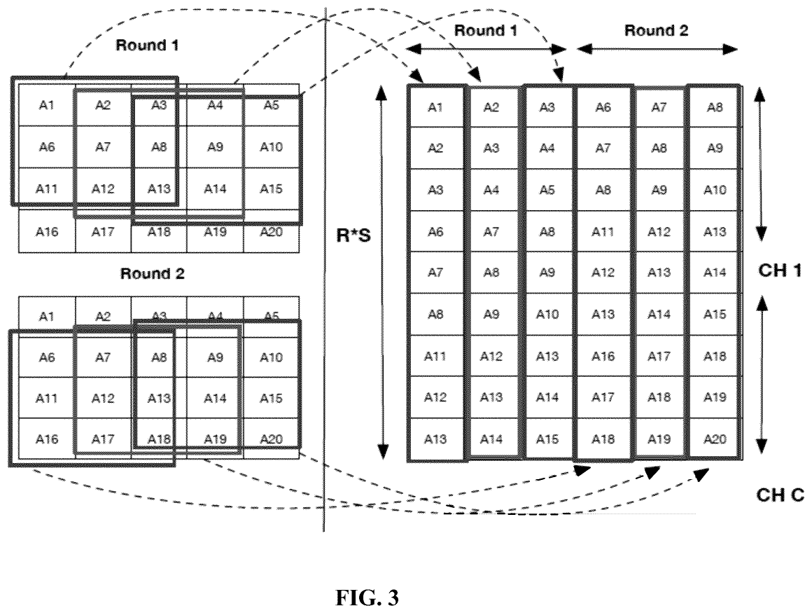

FIG. 3 illustrates matrix-matrix multiplication for performing a convolution operation. To structure the convolution operation as matrix multiplication, two matrices are created from the two inputs of a convolution layer: input feature map and the K filters. FIG. 3 illustrates how the two matrices are built. The product of these two matrices will be equivalent to the result of the convolution operation. For building the weight matrix, each filter is mapped to one row of the weight matrix. When there are K filters, there will be K rows in the weight matrix. The number of columns in the weight matrix is R×S×C. In contrast to the weight matrix, a more complex transformation, the image-to-column (IM2COL) transformation, is required to build a 2-D matrix from the original 3-D input feature map. As mentioned above, the IM2COL result depends on the kernel size and the stride size, which are the two parameters of the convolution operation. In convolution, each filter slides across different positions in the input feature map. The elements in the input feature map covered by the filter are referred to as a patch or a tile. Patches are often overlapped with each other when the stride size is less than the filter size. This overlap results in the repetition of the same element of the input feature map in multiple patches. That is, a convolution operation involves sliding a smaller filter window over the input array with a stride size, producing patches. The sliding-window nature of the convolution operation introduces overlaps between the patches. As described in more detail herein, localities resulting from this overlap are exploited to enable reading the input feature map from the memory block a single time. Referring to FIG. 3, the IM2CoL transformation is shown with an example filter of size (3×3×C) and a stride of 1. Each column of the matrix produced by the IM2CoL transformation corresponds to one patch where the filter is applied for all C channels, and it has R×S×C rows.

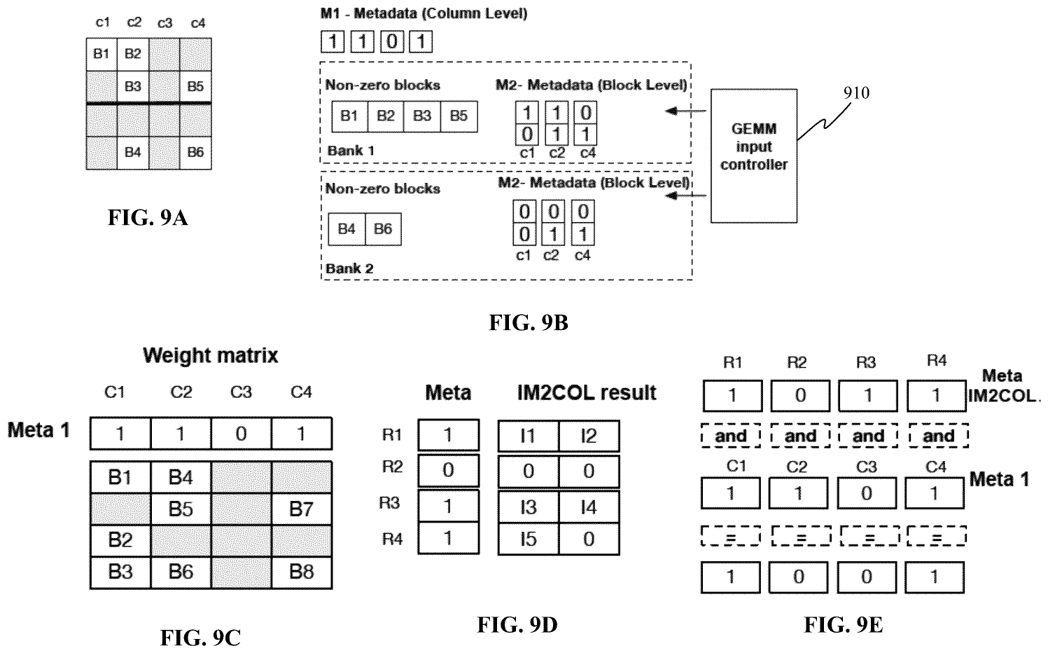

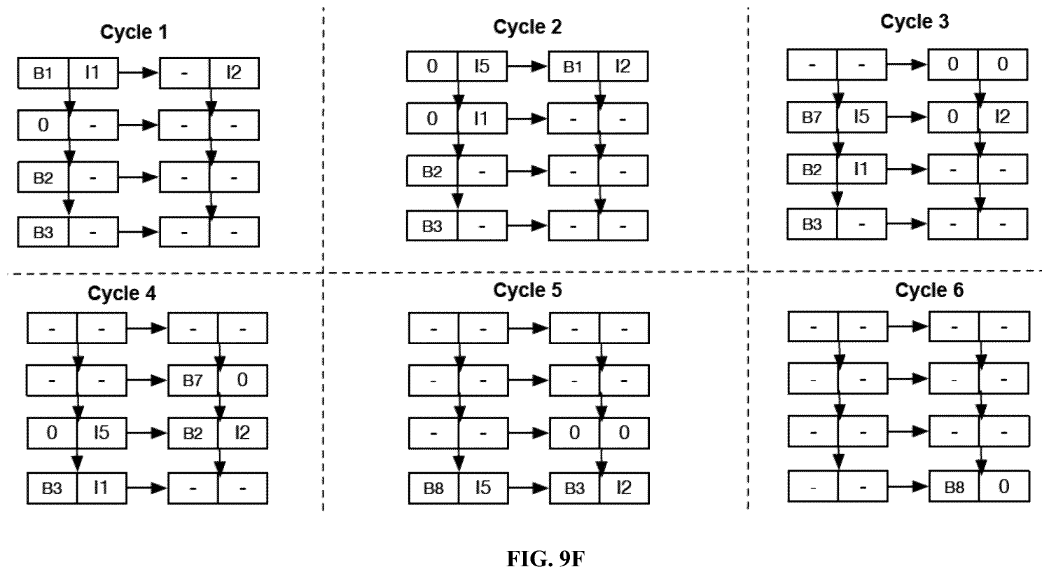

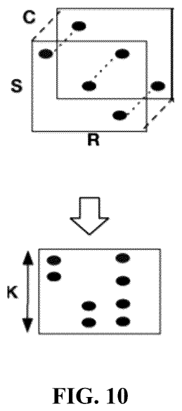

FIG. 4 shows an example implementation of the hardware accelerator of FIG. 2. Referring to FIG. 4, hardware accelerator 450 is an example implementation of the hardware accelerator 200. As can be seen, hardware accelerator 450 includes IM2COL unit 460; GEMM block 470; GEMM input controller 472; GEMM output controller 474; memory (which may be implemented as SRAM) including a first storage 480 for storing metadata of the filters (see e.g., FIGS. 9B and 9C), second storage 482 for storing input feature map (ifmap), third storage 484 for storing filters, and fourth storage 486 for storing the output feature map (ofmap); IM2COL output buffers 488; and compressor 490. Advantageously, the hardware IM2COL unit 460 simplifies the hardware acceleration for the GEMM block 470 without the need for complex interconnection networks.

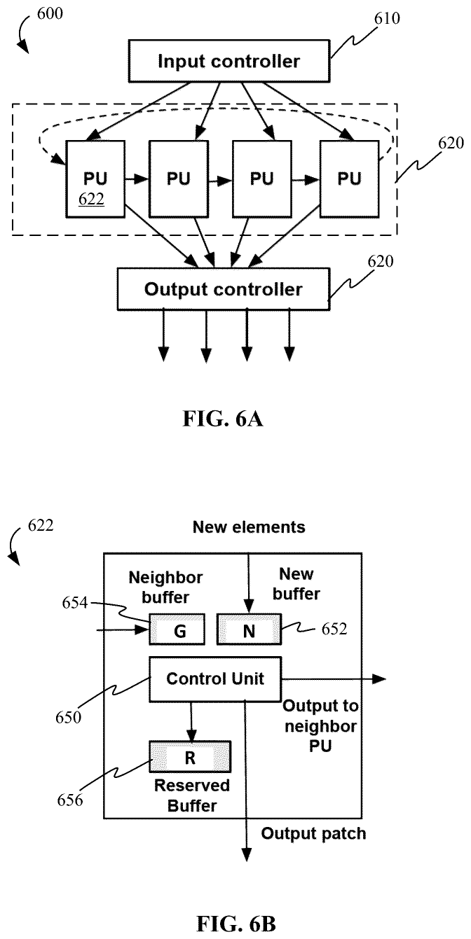

The IM2COL unit 460 reads the input feature map from the second storage 482, which is in the form of a 3-D array, and creates a set of linearized patches to output a 2-D matrix for the GEMM block 470. The IM2COL unit 460 is described in more detail with respect to FIGS. 6A and 6B.

The GEMM block 470 is formed of an M×N array of processing elements (PEs). The GEMM block 470 can have a reconfigurable, systolic array-based design that can be configured as a tall array and a square array, as needed. The GEMM block 470 may be implemented such as described with respect to FIGS. 5A and 5B.

The GEMM input controller 472 is used to control inputs, such as filters and the resulting output of the IM2COL unit 460, to the GEMM block 470. The GEMM output controller 474 is used to control outputs, such as an output feature map, from the GEMM block 470. The controllers 472 and 474 can be implemented using any suitable processing element(s) (e.g., microprocessor, integrated circuit, state machine, etc.).

The output buffers 488 hold the resulting output of the IM2COL unit 460 in advance of loading to the GEMM block 470.

The compressor 490 supports the handling of sparsity in the result of the IM2COL transformation. In particular, the compressor 490 can be used to identify a block of zeros in the result of the IM2COL transformation so that the zeros can be skipped at block granularity by the GEMM input controller 472. The compressor 490 can be implemented using any suitable circuitry (e.g., microprocessor, integrated circuit, etc.). In operation, the compressor 490 creates a bitmap for every block coming out of the IM2COL unit 460. If all elements in a block in the output of the IM2COL unit 460 are zeros, the bit is set to zero for that block; otherwise, the bit set to one. Subsequently, the GEMM input controller 472 of the GEMM block 470 uses this bitmap to skip blocks with all zeros on-the-fly. Thus, it is possible to elide multiply-accumulate operations when an operand is zero even before entering the systolic array of the GEMM block 470. FIGS. 9A-9F illustrate how the zero columns in the weight matrix and the zero rows in the output of the IM2COL unit 460 are skipped.

Further, it is not necessary to stream the column of filters (e.g., stored in third storage 484) when such a block of zeros is detected. For example, once the weights for filters are learned during the training phase, the weights are divided into blocks, where the block size is equal to the group size used for pruning. In addition, to minimize the memory footprint for storing filters during inference, the filters can be converted into a sparse representation that is aware of the number of memory banks in the design. All non-zero blocks are stored separately in one array that is distributed in multiple banks based on the row index of the block and two bitmap arrays are used to store the metadata. One bitmap array encodes whether a column has any non-zeros in the filter matrix. The other bitmap array maintains whether a block in a non-zero column is non-zero.

Accordingly, through the illustrated sparsity-aware design, it is possible to identify and skip the zeros on the fly and in block granularity.

FIGS. 5A and 5B demonstrate a dynamic reconfigurable GEMM block. Referring to FIGS. 5A and 5B, dynamic reconfigurability of the GEMM block (e.g., GEMM block 220 of FIG. 2, GEMM block 470 of FIG. 4) supports hardware implementation CNN layers with different attributes. That is, the PEs in a reconfigurable GEMM block 500 can be configured either as one tall array or multiple small arrays. Each such configuration has the same number of columns. This enhancement allows the design to be more adaptive to different layer shapes and thus maintains high PE utilization under different conditions. In detail, the dynamic reconfigurable GEMM block 500 can be configured as multiple GEMM blocks (e.g., first GEMM block 510 and second GEMM block 520; of course, more GEMM blocks and corresponding image-to-column blocks can be used) with square-shaped systolic arrays of PEs or a single tall-thin unit. The tall-thin shape better balances the memory bandwidth requirement of the GEMM block and the throughput of IM2COL unit, which allows efficient pipelining of operations between the PEs performing the matrix multiplication with the patch units executing the IM2COL reorganization. This dynamic reconfigurability of the GEMM blocks enables the described hardware accelerator to achieve high PE utilization with various kinds of convolutional layers that differ in the number of filters, kernel size, stride values, and feature map dimensions.

Referring to FIG. 5A, the reconfigurable GEMM block 500 can be implemented as a first GEMM block 510 and a second GEMM block 520. In such an implementation, the hardware accelerator includes a mode selector 530 and both a first image-to-column block 460-1 and a second image-to-column block 460-2, each implemented as described with respect to image-to-column unit 460 of FIG. 4 (including details associated with FIGS. 6A and 6B). The mode selector 530 is used to configure the hardware accelerator for a tall mode where the first GEMM block 510 and second GEMM block 520 are combined to form a tall systolic array with one image-to-column block in use (i.e., the first image-to-column block 460-1) and a square mode where each GEMM block (e.g., first GEMM block 510 and second GEMM block 520) with corresponding image-to-column block (e.g., first image-to-column block 460-1 and second image-to-column block 460-2) is separately operated. For example, in the tall mode, the height of the array is larger than the width of the array, the second image-to-column block is disabled, and the second GEMM block 520 receives column input from the processing elements of the first GEMM block 510.

The mode selector 530 can be a set of multiplexers (MUXs), with one MUX for each column, which is controlled by a mode selection signal referred to in the figure as the “tall mode” enable signal. The tall_mode enable signal can be set based on a mode register dynamically depending on the structure of a layer. Hence, the PEs now can receive the input either from the PEs above (i.e., in tall mode) or can get the input from a different IM2COL unit (i.e., in square mode).

Referring to FIG. 5B, the weight matrix 540 is broadcast to all small systolic arrays when the GEMM block is configured as smaller systolic arrays (i.e., in square mode). Each small GEMM block (e.g., first GEMM block 510 and second GEMM block 520) receives the feature map input (fmap 1 550, fmap 2 560) from their assigned IM2COL units (e.g., first image-to-column block 460-1 and second image-to-column block 460-2). In this configuration, the two GEMM blocks can compute two independent groups of columns of the final result matrix (i.e., first GEMM block 510 computes result columns from 0 to N/2, and second GEMM block 520 computes the columns from N/2+1 to N).

In some cases, more than two IM2COL units may be used with the two GEMM blocks. For example, in a prototype built by the inventors, four IM2COL units were used: a main IM2COL unit and three other IM2COL units. The main IM2COL unit (e.g., first image-to-column block 460-1) is used when the GEMM block 500 is in the tall mode and used in the tall array configuration. The other IM2COL units are smaller in size to reduce the overall area. This dynamic reorganization of the GEMM block's systolic array coupled with the multiple IM2COL units enables the hardware to maintain high PE utilization for various CNN layers with different shapes.

Accordingly, unlike prior designs of systolic arrays for GEMM acceleration, the described implementation includes dynamic reconfigurability, enabling the GEMM block to be configured either as a tall shaped systolic array (the height is considerably larger than the width) to maximize data reuse or as multiple GEMM blocks with square shaped systolic arrays.

There are numerous benefits in using a tall-shape systolic array-based architecture for GEMM. First, one of the inputs of the GEMM block comes from the IM2COL unit. Using a tall shape array reduces the memory bandwidth requirement for the input arriving from the IM2COL unit. Thus, it is possible to attain high PE utilization in the GEMM block with less throughput from the IM2COL unit. This helps build the IM2COL unit with fewer resources and memory bandwidth requirements. Second, the tall array helps the design to exploit sparsity in the output of the IM2COL unit to skip zeros and increase performance, described in more detail with respect to FIGS. 9A-9F. As the width of the tall array is smaller than its height, fewer columns from the IM2COL transformation enter the systolic array at any instant of time, which increases the opportunity for detecting and skipping entire rows of inputs with zeros before entering the systolic array. In essence, using a tall-shape array helps to simplify the mechanism to skip the redundant computation involving zeros in the input feature map.

As mentioned, CNNs have multiple layers that can be of different shapes and sizes. With a fixed configuration of hardware PEs, they can be underutilized for some layers, shapes and/or sizes. Each filter forms a row of the weight matrix that is assigned to a distinct row of the systolic array. When the GEMM block is configured as a tall systolic array (e.g., in tall mode), and the number of filters is relatively smaller than the systolic array's height (e.g., 128), some PEs will remain unused.

Most CNNs have one or more fully connected layers at the end of the network. The inputs to the fully connected layers are the matrix weights learned during the inference and the output feature map resulting from the final pooling or convolutional layer that is flattened to a vector. With a batch size of 1, the computation for a fully connected layer is equivalent to matrix-vector multiplication. By increasing the batch size, it is possible to structure the fully connected layer as a matrix-matrix multiplication operation. This can be implemented in tall-mode and the batch sizes need not be large to utilize the whole array of PEs fully (e.g., can be as small as 4).

FIGS. 6A and 6B illustrate an image-to-column unit. Referring to FIG. 6A, an image-to-column block 600 of an image-to-column unit (e.g., IM2COL unit 460 of FIG. 4) includes an input controller 610 coupled to receive an input feature map from a memory block (e.g., second storage 482 of FIG. 4); a series of patch units 620 forming a ring network and coupled to the input controller 610 to receive new elements of the input feature map, where each patch unit 622 in the series of patch units 620 is used for generating one output patch; and an output controller 630 coupled to receive each output patch from the series of patch units 620, where the output controller 630 organizes each output patch for output to the GEMM block (e.g., GEMM block 470 of FIG. 4, and which may be first stored in buffers 488 shown in FIG. 4). Controllers 610 and 630 can be implemented using any suitable processing element (e.g., microprocessor, integrated circuit, state machine, etc.).

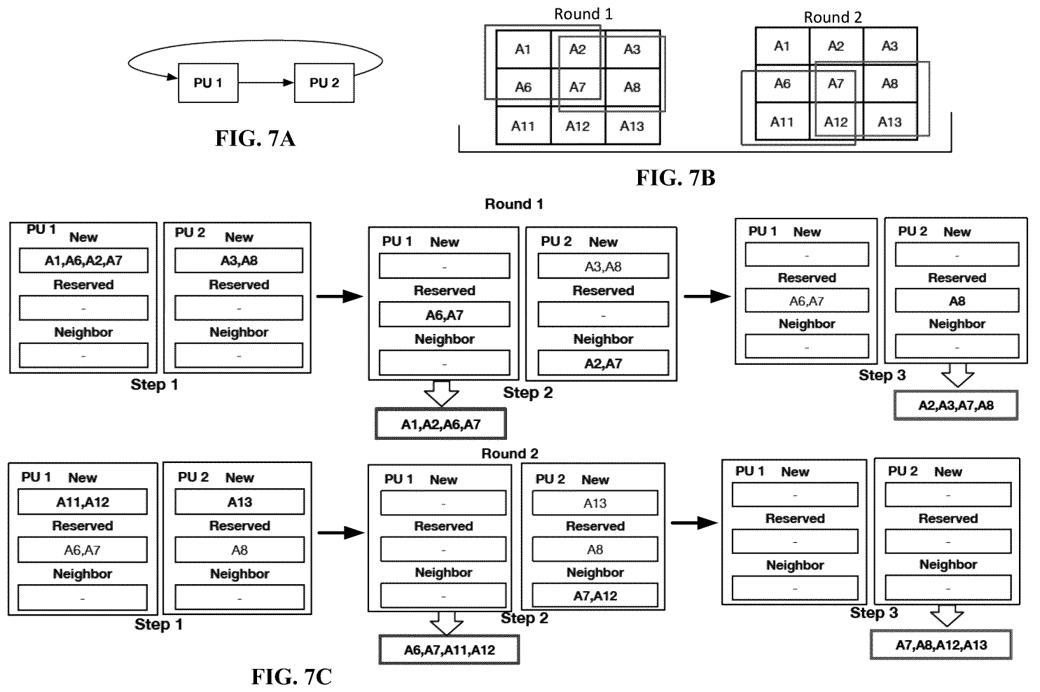

Because the series of patch units 620 are connected in a manner that forms a ring network, the patch units are able to communicate elements locally and avoid redundant accesses to the input feature map in memory. Each patch unit 622 in the series of patch units 620 includes a series of local buffers (see FIG. 6B) that exploit localities resulting from an overlap between the output patches as a filter slides over the input feature map horizontally and vertically (as described in more detail with respect to FIGS. 7A-7C), where each slide corresponds to a round, and where the exploitation results in reading the input feature map from the memory block one time. For example, as elements of the input feature map are streamed in to the series of patch units, each patch unit forwards overlapping elements to a neighboring patch unit in the series of patch units, where the overlapping elements are elements of the input feature map that are shared between two rounds of sliding a filter as the filter slides over the input feature map horizontally and vertically.

In operation, the input controller 610 reads the input feature map from the memory storage and forwards the bits of the input feature map to the appropriate patch units. Apart from sending values from the input feature map to the respective patch units, the input controller 610 can also maintain extra metadata for every scheduled patch. This metadata carries information about the position of the current patch. For some convolution layers, stride size is the same as kernel size. In those cases, there is no overlap between the patches. For those scenarios, the input control forwards its output directly to the output controller by skipping the patch units.

Referring to FIG. 6B, each patch unit 622 in the series of patch units 620 includes a control unit 650, a new buffer 652, a neighbor buffer 654, and a reserved buffer 656. Each patch unit 622 is responsible for building one patch at a time.

The new buffer (N) 652 maintains the newly fetched element received from the input controller 610. The neighbor buffer (G) 654 stores the elements received from the neighboring patch unit, for example, any overlapping elements of the input feature map. The reserved buffer (R) 656 stores some of the elements previously received at that patch unit in the previous rounds. The row and column indices (i.e., coordinates) along with the value for each element are stored. The control unit 650 within each patch unit 622 manages the buffers (new buffer 652, neighbor buffer 654, and reserved buffer 656) and generates patches. The control unit 650 decides whether an element needs to be forwarded to the neighboring patch unit and whether the element should be maintained in the reserved buffer 656 for future use. The control unit 650 can be implemented as any suitable processing element (e.g., microprocessor, integrated circuit, state machine, etc.).

Although not shown, it is possible to include a pooling operation (e.g., MAX pooling) to the output of the patch units. The pooling layers help to summarize the features generated by a convolution layer. There are two common types of pooling layers: max pooling and average pooling. Among them, max pooling, which picks the maximum element from a feature covered by the filter, is more common. Similar to convolution layers, the pooling layer has two parameters, filter size and the stride size.

Advantageously, the illustrated design of the hardware IM2COL unit provides energy efficiency and performance. Accessing the smaller memory storage and performing integer operations (for computing on row and column indices) consumes significantly less energy than accessing DRAM and large SRAMs. Further, the distributed collection of patch units unlocks extra parallelism beyond parallelism among the channels, allowing multiple patches to be built simultaneously by different patch units in the IM2CoL unit, boosting performance.

FIGS. 7A-7C illustrate example operations of an image-to-column unit in accordance with embodiments described herein.

Referring to FIGS. 3, 6A, and 6B, a unique identifier (“patch identifier”) identifies each patch (e.g., row and column index of top-left element such as shown in FIG. 3). The control unit 650 in a patch unit 622 uses the patch identifier, the filter size, and the stride size to determine which elements need to be (1) fetched from the input feature map, (2) forwarded to the neighboring patch units, and (3) stored in the reserved buffer 656 for future rounds. For example, all elements are fetched from the input feature map when a patch unit 622 processes the first patch in the first round.

All elements that are necessary for adjacent patches in a given round are provided by the neighboring patch units in the series of patch units 620. A patch unit typically receives K²−K×S elements from the neighboring patches as long as it is not the first patch in a given round, where K is the size of the kernel and S is the stride size. All patches that belong to the same column (i.e., column index of the top-left element) can be assigned in different rounds to the same patch unit. Hence, the patch units also store some elements that may be useful to build patches in subsequent rounds in the reserved buffer 656. This procedure is repeated for all C channels in the feature map.

The total number of elements that are overlapped between the vertical patches for a given filter size is C×W×(K−S) where W is the width of the input feature map. This is the maximum data reuse that can be attained with the reserved buffer. Further, the width and the channel size are inversely proportional to each other. For example, the first few layers of a CNN often have a small number of channels that are wider. In contrast, the later layers of the CNN have larger channels of smaller width. Thus, a small reserved buffer 656 can provide significant data reuse even for larger layers. When the number of overlapped elements between the vertical patches is larger than the size of the reserved buffer 656, the input controller 610 skips the reserved buffer 656 and fetches the element again from second storage 482 (e.g., SRAM) as shown in FIG. 4. In such cases, data reuse is restricted to horizontally adjacent patches. Finally, the output controller 630 organizes patches formed by each patch unit and manages communications with the GEMM block (e.g., GEMM block 470 of FIG. 4). The output controller 630 can coordinate double buffering (e.g., buffers 488) that enables the overlapped execution of the IM2COL unit 460 and the GEMM block 470.

FIGS. 7A-7C illustrate an example process flow of generating patches using two patch units PU1 and PU2 as shown in FIG. 7A, which may be implemented such as described in FIGS. 6A and 6B. The sliding window showing the patches for PU1 and PU2 for the two rounds is shown in FIG. 7B. With reference to FIGS. 6A, 6B, 7A, 7B, and 7C, PU1 receives four elements (A1, A6, A2, A7) from the input controller 610 and stores the four elements in the new buffer 652 in step 1. Similarly, PU2 receives two new elements (A3, A8). PU2 will receive the other elements in the window (e.g., A2, A7) from the PU1 in subsequent steps. For example, as shown in step 2, the first patch A1, A2, A6, A7 are output from PU1 and A6 and A7 are stored in the reserved buffer 656 of PU1 in advance of their use in the second round for PU1. In addition, A2 and A7 are received in the neighbor buffer 654 of PU2. In step 3, the first patch of A2, A3, A7, A8 is output from PU2 and A8 is stored in the reserved buffer 656 of PU2 in advance of its use in the second round for PU2. For round 2, PU1 receives two new elements (A11, A12) from the input controller 610 and stores the two elements in the new buffer 652 in step 1. Similarly, PU2 receives one new element (A13). In step 2 of round 2, the second patch A6, A7, A11, A12 is able to be output from PU1 based on the two elements in the new buffer 652 and the two elements stored in the reserved buffer 656 from the previous round. For PU2, A7 and A12 are received in the neighbor buffer 654. Last, in step 3 of round 2, A7, A8, A12, A13 is output from PU2 based on the one element in the new buffer 652, the one element in the reserved buffer 656, and the two elements in the neighbor buffer 654.

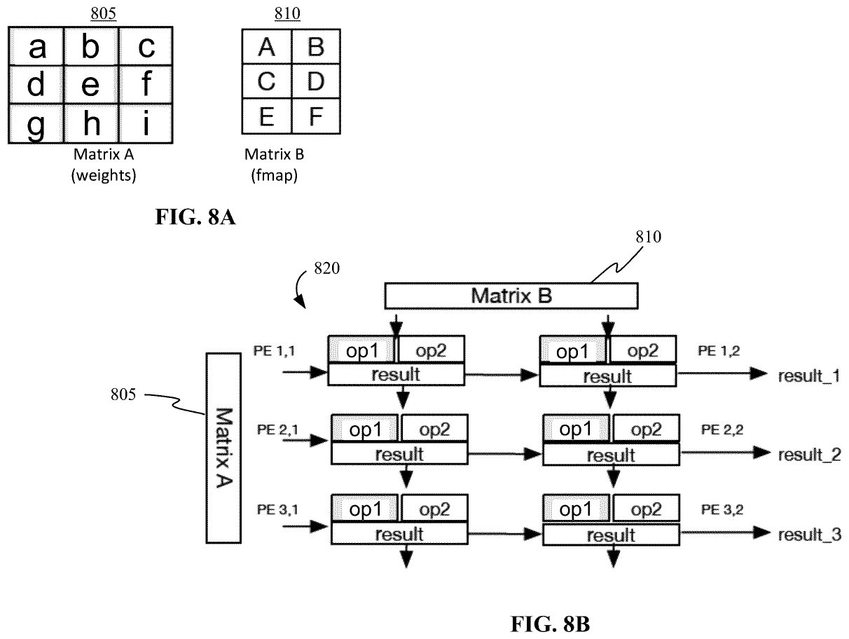

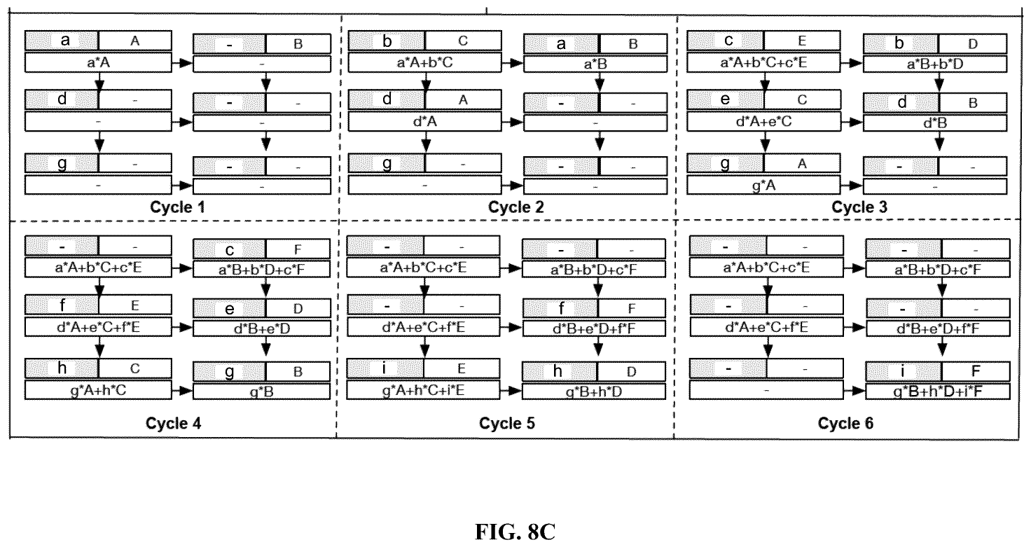

FIGS. 8A-8C illustrate example operations of a GEMM block in accordance with embodiments described herein. FIG. 8A shows inputs to the GEMM block, FIG. 8B shows a tall array configuration for the GEM block, and FIG. 8C illustrates a cycle-by-cycle GEMM computation with current inputs and partial results computed for the processing elements in the GEMM block of FIG. 8B.

FIG. 8A shows the weight matrix, Matrix A 805, from the filter and the output of the IM2COL transformation, Matrix B 810, that forms the input to the GEMM block 820. The values of the filter matrix (Matrix A 805) enter the systolic array of the GEMM block 820 from left-to-right. While the result of the IM2COL unit (Matrix B 810) enters the systolic array from top-to-bottom.

As illustrated by FIG. 8C, the GEMM block uses an output-stationary dataflow where a given processing element (PE) computes the final result by accumulating the partial products for a particular element of the output. This output-stationary dataflow ensures maximum reuse of the output data. Using a tall array also helps attain high data reuse for the result of the IM2COL transformation.

Load imbalance happens in sparse CNNs due to the uneven distribution of the non-zeros in weight and feature map inputs. The choice of the dataflow and the data reuse strategies determine the source of the load imbalance in an accelerator. Generally, accelerators adopt either an input-stationary or an output-stationary dataflow. Subsequently, an input-stationary dataflow can be weight stationary or feature map stationary. In input-stationary dataflow, one of the inputs is held stationary in the PEs while the other input is broadcast to each PE to ensure data reuse. When there is an uneven distribution of non-zeros in the inputs, some PEs may receive fewer inputs, forcing them to remain idle until the other PEs process their inputs before they all can receive new inputs.

Through using an output-stationary dataflow with a tall systolic array (e.g., as illustrated by FIG. 8C), it is possible to minimize load imbalance. In a tall systolic array, the feature map values are passed through as many PEs as possible to ensure maximum data reuse. As described above, the zeros in the feature map input are skipped inside the input controller before entering the systolic array. Thus, the non-zeros are skipped for all PEs (not just for an individual PE) in the systolic array. The ability to detect the zeros before applying inputs to the GEMM (e.g., via compressor 490) avoids the potential load imbalance caused by the uneven distribution of non-zeros in the feature map as well as the zeros in the weights outside the PE when the zeros span the whole filters (i.e., an entire column of the weight matrix).

For partially zero columns in the weight matrix (i.e., some blocks are zeros, some non-zeros), some PEs may receive a zero block while others receive a non-zero block. This can introduce a work imbalance between the PEs. One way to improve the load balance in the PEs is to rearrange (shuffled) the non-zero blocks in the weights offline to make the distribution of the non-zero blocks more balanced. However, this reshuffling can change the position of the output channels, requiring an additional step to reorder the output before the next layer uses them. Thus, minimizing average imbalance through the use of the compressor 490 can further reduce complexity introduced by additional load balancing steps.

As mentioned above, most CNNs have sparsity in both filters and the input feature map. That is, a fraction of the values in the layers' weight and feature map are zeros. During training of a neural network, a pruning step is often applied to remove unimportant and redundant weights. Pruning reduces computation and memory footprint by eliminating weights after the training phase without substantively changing network accuracy. However, pruning results in sparse matrices; that is, portions of the array have many zero elements (e.g., numerous zeros in the final trained weights). Additionally, some zeros can also appear in the feature map input. Unlike zeros in the weights, the zeros in the feature map input need to be identified at run-time.

To support sparsity during inference, a custom sparse format is presented herein to store the filters pruned with a structured sparsity learning (SSL) pruning method using a group-wise pruning approach, illustrated in FIG. 10. For run-time handling of sparsity in the feature map inputs, a block of entries with all zeros in the result of the IM2COL transformation are identified on-the-fly and tagged. These two techniques enable the hardware accelerator to skip rows and columns with all zeros before entering the systolic array of the GEMM block without requiring extra costly hardware for intersection or introducing any redundant zeros. Further, the described techniques also allow the multiply-accumulate (MAC) units in the processing elements of the GEMM block to be gated when an operand is zero. These techniques can also provide high bandwidth access to the filters necessary to keep the PEs active for the tall systolic array and output-stationary dataflow.

FIGS. 9A-9F illustrate techniques for handling sparsity in inputs to the GEMM block in accordance with embodiments described herein. FIG. 9A shows a dense representation of a weight matrix; and FIG. 9B shows a custom sparse format for the weight matrix. Referring to FIGS. 9A and 9B, once the weights for the filters are learned during the training phase, the weights can be divided into blocks. The block size is equal to the group size used for pruning, which is a design parameter. Logically, the filter matrix will be 2-D matrix of blocks when viewed in the dense representation as shown in FIG. 9A. To minimize the memory footprint for storing the filters during the inference, the filters are converted into a sparse representation that is aware of the number of SRAM banks in the design. The sparse format uses three arrays to store the pruned weights compactly. Referring to FIG. 9B, all non-zero blocks are stored separately in one array (Array A) that is distributed in multiple banks based on the row index of the block (i.e., vertical position in the filter matrix). Two bitmap arrays M1 and M2 are used to store the metadata. The bitmap array M1 encodes whether a column has any non-zeros in the filter matrix. A zero in the bitmap array M1 indicates an empty column. The bitmap array M2 maintains whether a block in a non-zero column is non-zero. A zero in M2 indicates the corresponding block is zero (i.e., as a block is a collection of values, it implies that all values in the block are zeros). These three arrays (i.e., A, M1, and M2) are distributed across the various banks of the SRAM so that the GEMM input controller 910 (e.g., GEMM input controller 472 of FIG. 4) for the GEMM block can access them in parallel.

FIGS. 9C-9F illustrate how the zero columns in the weight matrix and the zero rows in the output of the IM2COL unit are skipped. FIG. 9C shows a weight matrix and its column bitmap, FIG. 9D shows an IM2COL result and its row bitmap, and FIG. 9E shows logic to skip the non-zero rows and columns. FIG. 9F shows cycle-by-cycle execution of GEMM in the systolic array after skipping the zero columns and rows. Referring to FIG. 9C, it can be seen that the metadata for the weight matrix/filters indicates which columns have all zeros. In this case C3 has all zeros. Referring to FIG. 9D, the row bitmap indicates the metadata about rows with all zeros. In this case, R2 has all zeros. Referring to FIG. 9E, if a row or column is all zeros, all such rows and columns can be skipped (e.g., via an AND operation of the row and column data).

Referring to FIG. 9F, as an illustration of a GEMM computation when rows and columns are skipped, the first element of column C4 will be fetched by the first PE in cycle 2, skipping columns C2 and C3.

As can be seen, the described hardware accelerator can efficiently handle zeros in both inputs: weights and the input feature map. In particular, the described hardware accelerator exploits sparsity to skip data transfer and computation for sparse regions. A group-wise pruning approach results in a new sparse format, which substantially reduces the storage requirement for the weights in comparison to random pruning techniques and provides high bandwidth for a tall-thin systolic array.

In addition, by tagging blocks of zeros in the result of the IM2COL unit and skipping zero elements before entering the systolic array, computation cycles and memory transfers can be saved, relieving the processing elements of the GEMM block from performing extra costly operations (e.g., intersection) and redundant operations.

Advantageously, the described techniques support sparsities in both inputs without requiring any index matching units inside the PEs.

The described design is suitable for sparse convolutional networks, supporting sparse weights and feature maps tailored for the neural network accelerator. In addition, the design is applicable for a variety of configurations (is able to achieve generality) by supporting various CNN layers, such as fully connected and pooling layers, while maintaining high processing element (PE) utilization for various CNN layers.

FIG. 10 illustrates a pruning operation. Referring to FIG. 10, a 3-D filter (top) is converted to a 2-D representation (bottom). FIG. 10 shows resulting zeros in the 2-D matrix representation (bottom) of the filter while pruning the filter using a group-wise filter. A dark dot indicates that the point is being pruned. The group-wise filter is based on Structure Sparsity Learning (SSL), which is a generic approach that can be applied in different levels, including filters, channels, and shapes. For the described group-wise filter, SSL is applied at the shape level, but optimized by pruning in a more fine-grained fashion. In particular, the weights below a threshold are zeroed in some but not all elements of a shape. This generates zero blocks of a certain size (i.e., the number of filters in the group).

As briefly mentioned above, a prototype was designed based on the above illustrative embodiments. The prototype design is parameterizable with M rows and N columns in the systolic array. In the prototype design, each row of the GEMM block handles multiple rows of the filter matrix. The specific prototype used 128 rows of PEs and 4 columns. These numbers are chosen based on the characteristic of common CNN layers. Further, each row of the systolic array can be assigned multiple rows of the filter matrix depending on the scheduling mode. The majority of layers in state-of-the-art CNNs have less than 512 rows of the filter matrix in each convolution layer.

The following table provides the specification of the prototype.

| Unit | | Size | | Area (mm2) |
|---|---|---|---|---|
| GEMM | #PE units | 512 | | 2.048 |
| | Multiplier width | 16 | Bits | |
| | Accumulator width | 24 | Bits | |
| | Systolic array | one (128 × 4) | | |
| | configurations | four (32 × 4) | | |
| | PE's local buffers | 2 | KB | |
| IM2COL | #PU units | 4 | | 1.137 |
| | Reserved buffers | 32 | KB | |
| | Other SRAM buffers | 2 | MB | |
| On-chip | Filter SRAM | 1 | MB | 5.426 |
| memory | Fmap SRAM | 512 | KB | |
| SPOTS total | | | | 8.611 |

Each PE has a single multiply-accumulate (MAC) unit that uses two 16-bit fixed-point inputs and accumulates the result in a 24-bit register. To handle multiple rows of the filter matrix, each PE has K registers to compute the final result (e.g., in the prototype design, K=4). Each PE has three FIFOs: one FIFO for each arriving inputs (e.g., a first FIFO for the weights and a second FIFO for the fmap) and a third FIFO works as the work queue for the MAC unit. In GEMM, the coordinates of the elements of the two input matrices should match before multiplying the inputs. The fetch unit ensures that the inputs are sent to the PEs in the proper order; thus, there is no need for additional logic to perform index matching inside a PE. Additionally, the output-stationary dataflow as illustrated in FIG. 8C ensures all the partial products produced in a PE belongs to the same output element.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A hardware accelerator for neural network applications, comprising:
an image-to-column block comprising:
an input controller coupled to receive an input feature map from a memory block;
a series of patch units forming a ring network and coupled to the input controller to receive new elements of the input feature map, wherein each patch unit in the series of patch units is used for generating one output patch, and each patch unit in the series of patch units comprises a series of local buffers; and
an output controller coupled to receive each output patch from the series of patch units, wherein the output controller organizes each output patch for output to a general matrix-matrix multiplication (GEMM) block.

2. The hardware accelerator of claim 1, wherein the series of local buffers within each patch unit comprises:
a new buffer, wherein the new buffer maintains the new elements of the input feature map received from the input controller;
a neighbor buffer, wherein the neighbor buffer stores any overlapping elements of the input feature map received from a neighboring patch unit from the series of patch units;
a reserved buffer, wherein the reserved buffer stores elements of the input feature map previously received at a patch unit in a previous round of a filter sliding over the input feature map horizontally and vertically, wherein each slide of the filter corresponds to a round; and
a control unit that manages the new buffer, the neighbor buffer, and the reserved buffer, and generates the output patch using elements stored in the new buffer, the neighbor buffer, and the reserved buffer, wherein the control unit decides whether to forward the element from the input feature map to the neighboring patch unit or whether to maintain the element from the input feature map in the reserved buffer.

3. The hardware accelerator of claim 2, wherein the control unit uses a patch identifier, a filter size, and a stride size to determine which elements need to be fetched from the elements of the input feature map, forwarded to the neighboring patch unit, and stored in the reserved buffer.

4. The hardware accelerator of claim 3, wherein the output controller receives the output patches directly from the input controller when the stride size is equal to the filter size.

5. The hardware accelerator of claim 1, wherein the input controller communicates information about a position of a current patch to the series of patch units.

6. The hardware accelerator of claim 1, further comprising the GEMM block, wherein the GEMM block comprises a systolic array of processing elements, wherein the GEMM block receives each output patch and a weight matrix as inputs, and wherein the GEMM block computes an output feature map comprising rows and columns.

7. The hardware accelerator of claim 6, further comprising:
a second GEMM block; and
a second image-to-column block, wherein the second image-to-column block comprises:
a second input controller coupled to receive the input feature map from the memory block;
a second series of patch units configured in a second ring network and coupled to the second input controller to receive new elements of the input feature map; and
a second output controller coupled to receive each output patch from the second series of patch units, wherein the second output controller organizes each output patch for output to the second GEMM block.

8. The hardware accelerator of claim 7, further comprising a mode selector for configuring the GEMM block and the second GEMM block according to a tall mode and a square mode.

9. The hardware accelerator of claim 8, wherein the mode selector comprises a multiplexer (MUX) coupled at a first input of the MUX to a corresponding column of the GEMM block, coupled at a second input of the MUX to receive elements of an output patch from the second image-to-column block, coupled at an output of the MUX to a corresponding column of the second GEMM block, and coupled to receive a mode selection signal.

10. The hardware accelerator of claim 8, wherein the tall mode configures the GEMM block and the second GEMM block as a combined GEMM block in a tall systolic array, wherein a height of the array is larger than a width of the array, wherein the second image-to-column block is disabled, and wherein the second GEMM block receives column input from the processing elements of the GEMM block.

11. The hardware accelerator of claim 8, wherein the square mode configures the GEMM block and the second GEMM block as distinct GEMM blocks, wherein the GEMM block and the second GEMM block separately compute independent groups of columns of the output feature map.

12. The hardware accelerator of claim 1, further comprising:
a compressor coupled to receive the output patches from the output controller, wherein the compressor determines whether any row of any of the output patches contain all zeroes and creates a bitmap for every block of the output patches indicating whether or not all elements in each block are zero; and
a GEMM input controller that determines which blocks from the output patches to send to the GEMM block based on the bitmap created by the compressor.

13. The hardware accelerator of claim 12, further comprising:
a first storage for storing a metadata filter, wherein the metadata filter contains information about zero columns of a weight matrix; and
a third storage for storing filters having corresponding weights of the weight matrix,
wherein the GEMM input controller reads the metadata filter from the first storage for selecting the weights to send to the GEMM block.

14. A method of performing an inferencing-related application, the method comprising:
generating convolutional layers of a neural network application using a hardware accelerator comprising:
an image-to-column block comprising:
an input controller coupled to receive an input feature map from a memory block;
a series of patch units forming a ring network and coupled to the input controller to receive new elements of the input feature map, wherein each patch unit in the series of patch units is used for generating one output patch, and each patch unit in the series of patch units comprises a series of local buffers; and
an output controller coupled to receive each output patch from the series of patch units, wherein the output controller organizes each output patch for output to a general matrix-matrix multiplication (GEMM) block.

15. The method of claim 14, wherein as elements of the input feature map are streamed in to the series of patch units, each patch unit forwards overlapping elements to a neighboring patch unit in the series of patch units, wherein the overlapping elements are elements of the input feature map that are shared between two rounds of sliding a filter as the filter slides over the input feature map horizontally and vertically, whereby the input feature map is read from the memory block one time.
